(19) United States
(12) Patent Application Publication
(10) Pub. No.: US 2021/0086348 A1
(43) Pub. Date: Mar. 25, 2021

(54) WASHING DEVICE FOR VEHICLES

(71) Applicant: Aleksei MOZHAR, Berlin (DE)

(72) Inventor: Aleksei MOZHAR, Berlin (DE)

(21) Appl. No.: 16/635,296

(22) PCT Filed: Jul. 30, 2018
(86) PCT No.: PCT/EP2018/070622

§ 371 Date: Jan. 30, 2020

(30) Foreign Application Priority Data
Jul. 31, 2017 (DE) 20 2017 004 032.8

(51) Int. Cl. B25J 9/00; B60S 3/04; B25J 11/00; B25J 17/02

(52) U.S. Cl. CPC B25J 9/0051; B25J 17/0266; B25J 11/0085; B60S 3/04

(57) ABSTRACT

The invention relates to a washing device for vehicles, which can clean the surface of a vehicle with high precision and with care. The claimed washing device comprises a delta robot (8, 32, 36, 48, 50) which supports a treatment element (6) on the operating-sided end.

The present invention refers to a washing device for vehicles. It refers in particular to an automated washing device for vehicles.

A washing system for vehicles and a method for washing vehicles is known from DE 10 2014 112 123 A1. According to this previously known proposal, vehicles are washed by industrial robots, which are designed as joint arm or swivel-arm robots and are adapted to imitate the manual cleaning of a vehicle.

The earlier proposal leaves a lot to be desired. Thus the present invention is based on the problem of providing an improved washing device for washing vehicles.

According to the proposal of the present invention, the washing device comprises at least one delta robot which carries a treatment element at its actuation-side end. A delta robot is an operating device based on parallelogram kinematics. Due to the special delta-kinematics, arm links form parallelograms when moving, so that the rotational degrees of freedom of the work plate attached to the arm links are significantly reduced. All arm links of the delta robot are usually articulated on this work plate. The other ends of the arm links can be connected to a pivoting drive arm, the pivoting movement of which causes the work plate to move. Alternatively or additionally, the or all arm links of the delta robot can be connected to an intermediate element which is movable. The intermediate element can only be moved linearly to increase the working radius. However, in order to achieve the best possible contact between the treatment element and the surface of the vehicle, it is preferable to pivot the intermediate element. The intermediate element should be pivotable by at least +/−50°, particularly preferably +/−70° and further particularly preferably +/−90°. The intermediate element is usually designed as a rigid support arm structure in lightweight construction. The intermediate element is preferably movable via linear guides. The intermediate element is preferably held movable on three linear guides. By changing the position of each individual linear guide, the intermediate element can also be pivoted within the previously mentioned limits to adjust the angular alignment of the work plate relative to the surface to be cleaned. The connection between the intermediate element and the linear guide is preferably made by pairs of connecting arms of connecting rods, which are articulated on both the linear guide and the intermediate element.

The delta robot can have three, preferably four rigid arm links, preferably all of which are connected to a base via pivotable drive arms. The drive arms can also be provided as a pair of drive arms, whereby the elements of a pair of drive arms usually extend parallel to each other and are each articulated at the same drive arm and at the work plate. This gives the work plate a more stable support and positional alignment.

The delta robot can be designed as a tripod robot or hexapod robot. The tripod robot is a motion machine with three drive elements and three degrees of freedom. The hexapod robot has six length-adjustable arm links and allows movability in six degrees of freedom, namely three translational and three rotational degrees of freedom. Due to the parallel arrangement of the drives, the hexapod robot has a better payload to deadweight ratio compared to serial robots. Especially when designed as hexapod robots, the variable-length arm links are preferably arranged on the rigid intermediate element and connected to it.

For a specific design, a tripod or hexapod design is used to support only the work plate. This support can be provided by non-driven arm links of the tripod or hexapod arrangement. At most, the arm links can have certain damping properties, i.e. they can be passively length-adjustable within limits. The alignment of the work plate and its positioning relative to the vehicle is preferably carried out exclusively by means of the connecting rods, which—as described above—are to be regarded as rigid arm links in the sense of the present invention and which act on an intermediate element and move it with a movability in six degrees of freedom, namely three translational and three rotational degrees of freedom. Between this intermediate element and the work plate there is the previously described design of the tripod or hexapod as an arrangement with non-driven arm links, which can only have the previously mentioned damping characteristic. However, the arm links can also be completely rigid.

The delta robot is able to perform movements quickly and effectively. In addition, the drive arms can be adjusted to achieve an angular adjustment of the work plate so that the work plate or the treatment element held by it can be positioned precisely parallel to the surface of the vehicle to be cleaned.

Compared to joint arm or swivel-arm robots, a delta robot accordingly allows a much higher frequency of intermittent movements, for example when the vehicle to be cleaned is to be scrubbed or polished.

Due to these performance characteristics of the delta robot, the washing device according to the invention can wash a vehicle much more intensively and better than according to the previously known solution according to DE 10 2014 112 123 A 1. In the sense of the present invention, delta robots in the technical sense are understood to be actuating elements referred to as delta or parallel robots, which have at least two, preferably three or four arm links.

A delta robot for realizing the present invention may have at least three parallel arm links, each forming parallelograms. It is nevertheless possible to use a delta robot with four or more arm links. A delta robot with four arm links is particularly suitable for adjusting the angular inclination of the work plate and thus for parallel alignment with the surface of the vehicle to be cleaned.

Preferably the treatment element is designed as a cleaning element adapted for direct contact with the surface of the vehicle. The treatment element is accordingly preferably a sponge or synthetic fur, a cloth or a brush. As part of the cleaning device, at least two treatment elements with different hardness and/or different thickness and/or different absorbency and/or different fiber length may be provided. The different treatment elements allow for an adapted treatment of the surface of a vehicle. It has been found that vehicles with a metallic paint finish require a different treatment than vehicles without a metallic paint finish. Vehicles are also sold with a nano-coating, which require a particularly gentle application of the treatment element. This is achieved on the one hand by the way the vehicle is treated. On the other hand, however, this is also achieved by selecting an appropriately designed treatment element for the respective treatment required. It goes without saying that this treatment element can be arranged so that it is still relatively movable in relation to the work plate, for example, in order to carry out a rotational movement, while the arm links of the delta robot move the treatment element translationally relative to the surface to be cleaned. This can improve the intensity of cleaning.

Alternatively, the treatment element can also be designed as a spray element. Such a spraying element is designed to spray on a usually liquid or pasty cleaning or care substance. A spray element is formed in particular by a nozzle element of a high-pressure cleaner, for example to spray on water, possibly containing cleaning agents, onto the vehicle during pre-washing. However, the spray element can also apply care substances alone in the form of wax, preservatives, sealers or other chemical substances. For this purpose, the spray element can have a heated spray can to make a rather viscous material more fluid by heating it. The spray element can have a high-pressure nozzle which discharges the substance from the nozzle at considerable pressure. However, the spray nozzle can also be operated at relatively low pressure. In particular, the spray nozzle can also produce a mist that settles evenly on the surface of the vehicle to be cleaned.

In addition or alternatively, the treatment element can be designed as a drying element for drying the vehicle. Such a drying element can be formed by a drying cloth. However, it can just as well be formed by a drying nozzle that uses high pressure to remove water droplets from the surface of the vehicle to be cleaned. In particular, the drying element can be designed in such a way that it lifts and removes the water droplets adhering to the vehicle in a knife-like manner, as described in principle in WO 2013/144556 A1.

The aforementioned treatment elements are usually connectable to the work plate or firmly connected to a segment of a work plate which can be connected to a robot-side segment of the work plate by means of a releasable lock in order to provide different treatment elements on the robot(s) as required. The exchange of the treatment elements is preferably carried out automatically, e.g. by means of a controllable coupling, which temporarily attaches the respective treatment element to the work plate on the robot side. If the treatment element is designed as a spray element, there is at least one, possibly a plurality of lines between the base of the robot and the work plate for supplying cleaning or care substances to the work plate.

In a manner known per se, a treatment element in the form of a spray element may be provided at the entrance to a car wash, which may be an embodiment of a washing device for vehicles. A plurality of spray elements usually act on the vehicle simultaneously. The delta robots with the spray elements are preferably provided and formed relative to each other in such a way that they can act on the side wheels of the vehicle to be cleaned. A washing device equipped with a spray element usually sweeps over the entire vehicle during pre-cleaning at the entrance of a car wash. Already at this stage, data on the three-dimensional shape of the vehicle can be used to control the washing device so that the spray nozzle of the spray element can be positioned close relative to the vehicle without colliding with the vehicle or being too close to the vehicle, which can result in excessive water pressure that can damage the paint surface.

The washing device may be provided with a sensor which detects a possible previous contact between the treatment element and the vehicle and triggers a counteraction so that no damage is to be feared. This sensor can work contactlessly to detect an approach of the treatment element to the vehicle. In the case of a treatment element designed as a cleaning element, the sensor can also monitor the contact pressure against the surface of the vehicle, which can vary depending on the degree of soiling. By means of such a pressure sensor a closed-loop control circuit can be realized for monitoring a pre-set contact pressure, which, however, varies in sections over the vehicle.

According to a preferred further embodiment of the present invention, the delta robot is controlled by a control device which processes contour data on the shape of the vehicle to be cleaned for positioning the treatment element and cleaning intensity data. Based on the contour data, the treatment element is pressed against the surface of the vehicle to be cleaned in the desired orientation and with a predetermined contact pressure. The cleaning intensity data are usually broken down by location. In particular, the cleaning intensity data provide information on the cleaning effort varying over the surface of the vehicle. Accordingly, the cleaning intensity data allow a spatial breakdown of the respective cleaning intensity. The proposal is based on the recognition that different areas of the vehicle require different levels of cleaning. For example, the radiator and sometimes the bonnet and windscreen are considerably dirtier than the rear of the vehicle. In the area of the front of the vehicle, cleaning must be correspondingly more intensive, whereas cleaning should not be too aggressive, also with a view to protecting the surface of the vehicle, especially the painted surfaces. The cleaning intensity data vary over the surface of the vehicle at least one of the following parameters for washing the vehicle: acting pressure of the treatment element against the surface of the vehicle to be cleaned; acting speed of the treatment element against the surface of the vehicle to be cleaned; acting time in a predetermined surface area of the vehicle; acting movement pattern of the treatment element in a predetermined surface area of the vehicle. Thus, the cleaning intensity data can be used to set various cleaning parameters in a spatially varying manner when washing the surface of the vehicle. Heavily soiled surfaces are intensively cleaned, for example by increasing the acting pressure, acting time or acting speed. The acting speed is the relative movement between the treatment element and the surface. The acting time is usually related to a predetermined surface area of the vehicle. It is varied whether the treatment element is active over a longer period of time on a predetermined surface area, or whether the treatment element only sweeps the corresponding area for a short time. The acting movement pattern is the path taken by the treatment element when cleaning a predetermined surface area within it. This allows the treatment element to be moved back and forth alternately (scrubbing). However, the treatment element can also sweep the surface area to be cleaned in circular movements. These circular movements can be done by same radius or spiral-shaped. The corresponding movements can also be combined. In particular, spiral or circular alternating movements can also be performed.

The device may also have a 3D camera to detect the position of the vehicle in space. This 3D camera is usually used for 3D matching, in which the camera detects a few pixels of the vehicle. The pixels detected in this way are overlapped with pixels of a virtual representation of the vehicle (e.g. CAD file) in the course of 3D matching, so that the robot knows all surfaces and their extension by referring back to the CAD data.

In accordance with a preferred further development of the present invention, the delta robot is controlled by a control device depending on weather and/or seasonal data. With such data the cleaning process can be optimized. For example, in winter, i.e. in months with frost, a program can always be selected which first removes road salt adhering to a vehicle. If weather data indicate a long period of dryness and thus the absence of black ice, the control device can be set up in such a way that, despite temperatures below zero, it does not require intensive rinsing to wash off road salt at the start of a cleaning process. In the absence of precipitation in summer, for example, the control device at the start of a leaning process can also prioritize the removal of dust, for example by means of a spray element or even a blow nozzle that removes dust adhering to the vehicle. The weather data can be collected locally by a weather station assigned to the washing device. Alternatively or additionally, weather data based on observations from weather stations can be read in via an interface. If, for example, the gloss of the corresponding surfaces is analyzed for differentiation of the surfaces when analyzing surfaces of the vehicle beforehand, the presence of pollen can be deduced from weather data, for example in spring, in order to correct the gloss values determined.

According to another preferred design of the present invention, the washing device comprises a treatment element magazine to which the delta robot has access for an automated exchange of the treatment element. Accordingly, the treatment element is usually connected to the actuation-side end of the delta robot, i.e. the work plate, via a detachable coupling. The detachable coupling can be released automatically. For example, the treatment element can be attached to the work plate with a positive or non-positive fit. The treatment element magazine can be provided with actuating elements for releasing the connection between the work plate and the treatment element. Holding elements can also be provided to hold the treatment element to be replaced, so that a movement of the delta robot away from the treatment element magazine will cause the connection between the treatment element and the work plate to be loosened. Treatment elements with different contours are preferably provided on the treatment element magazine. These contoured treatment elements are provided to clean differently contoured surface areas of the vehicle in the best possible way. For example, the treatment element magazine can provide at least one specially shaped treatment element, which grips and cleans webs or grids in the area of ventilation openings on the vehicle body in the best possible way. The treatment elements can also be designed to suit the surface to be cleaned. For example, a treatment element for cleaning glass surfaces (headlamp covers, windows) may have a different mat composition and/or characteristics than a treatment element for washing the painted surfaces of the vehicle. Another individually adapted treatment element may be a rim brush or the like i.e. a treatment element specially designed for cleaning rims or tires.

A cassette divided into segments can also be used as a cleaning element. The delta robot can be controlled in such a way that only one of the segments is brought to act on the surface of the vehicle at a time. The segments can include identical or differently designed cleaning element segments. By means of an adapted control system, in particular angular alignment of the individual segments, these can be selectively brought into action, for example depending on the surface characteristics of the section of the vehicle to be cleaned.

According to another preferred design of the present invention, the washing device has a treatment element treatment means for the regeneration of used treatment elements. This proposal is based on the consideration that a treatment element only has a certain service life for cleaning, but can nevertheless be used again for cleaning a vehicle after regeneration. In the treatment element treatment station, the corresponding treatment element is processed and prepared for a renewed use for washing a vehicle. The control device can be designed in such a way that after each cleaning of an individual vehicle the corresponding treatment element is replaced and regenerated. Just as well, each change of a treatment element can lead to the fact that the respectively exchanged treatment element is also regenerated in the treatment element treatment means.

The treatment device preferably has a circumferential treatment section on which the treatment elements are cleaned and/or checked and/or provided with cleaning or polishing agents and/or exchanged and/or dried. It is thus conceivable to use a treatment element in the form of a cloth for drying the vehicle, with which the vehicle is dried as if by a human hand, the treatment element soaked with water then being transferred to the treatment element treatment means for cleaning or washing and drying. In this way, the vehicle can be dried with a drying cloth as a treatment element, just like with a human hand. This further development makes it possible to dry the vehicle completely, which is usually not possible with warm air drying, as used in car washes or gantry car washing systems. With previously known washing devices, water drops usually remain in certain areas of the vehicle, which are visible on the washed vehicle and leave streaks.

During regeneration of the treatment element, this element can also remain on the delta robot and be swung by activating the robot arms or a drive provided on the work plate to pivot or rotate the treatment element in order to remove adhering moisture. Alternatively, the treatment element can be uncoupled from the delta robot and regenerated in the treat element treatment means. As part of the preparation of the treatment element, it can also be warmed to be used as a preheated treatment element, especially as a preheated drying element, thus improving efficiency. For example, a preheated treatment element also improves the application of a care substance to the surface of the vehicle by increasing the flowability. Thus, a heating device may also be associated with the treatment element, which is operated when the treatment element acts against the surface of the vehicle. Such a heating device can be operated with a PTC heating element, for example, which can be easily and reliably adjusted to a specific operating temperature thanks to its self-regulating properties.

An inspection of the washing element in the treatment element treatment means is carried out in particular with regard to a fault-free condition of the treatment element in order to prevent faulty treatment elements from leaving scratches when washing the vehicle.

The reach of at least one robot extends beyond the line of symmetry relative to the longitudinal direction of the vehicle, so that a single robot is sufficient to clean the entire vehicle.

According to a preferred further development of the present invention, the washing device as a car wash is equipped with a moving means for moving the vehicle. The movement is usually relative to the at least one delta robot. The movement is usually continuous or discontinuous. However, the delta robot can also be arranged on a guide so that it can be moved around the circumference of a vehicle to be cleaned.

This delta robot or a plurality of delta robots can be absolutely mobile, whereby the mobility of the delta robots is usually provided in such a way that the vehicle can move relative to the robots, so that the delta robot(s) can be moved along with the vehicle on the one hand, but can still be positioned relative to the vehicle on the other hand. In addition, the treatment element is positioned by the arm links of the respective delta robots. The moving means of the car wash has the advantage, known per se, that a vehicle can be passed through a car wash in order to be released as a clean vehicle at the end of the washing process. The car wash of the present invention has a recognition station at the front in the direction of movement of the moving means and a washing station behind it in the direction of movement with at least one of the delta robots. The recognition station has a recognition means for recognizing the moving vehicle. For example, it is possible to identify the license plate of the vehicle with the recognition means. This enables a specific vehicle, whose parameters are stored in a data record of the control device, to be recognized and a predetermined cleaning program to be run. This makes it possible for the user of the vehicle to specify a predetermined cleaning program for this vehicle, which is carried out each time the license plate is recognized. However, a visual recognition device suitable for determining the overall contour of the vehicle may also be provided as a recognition means. An image of the vehicle, showing the contour of the vehicle and the different surfaces in their quality, can be generated as a data set, which is used to determine the contour data and cleaning intensity data. However, it may also be sufficient to identify the vehicle to such an extent that, by comparing it with data stored in a database, it can be determined which vehicle model and model year is to be washed. The recognition of model and model year leads to the retrieval of data about the corresponding vehicle from the database, through which the delta robot(s) are controlled.

The control device controlling the delta robot uses the information on the position, type and/or equipment of the vehicle determined by the detection means to specify a cleaning program for the corresponding vehicle. The cleaning program is not only given by the contour data and thus location information, where the treatment element comes into effect. Rather, the cleaning intensity data with spatial distribution for the best possible cleaning of the vehicle are also selected, read out or determined.

Preferably, the washing device has a washing station with a plurality of delta robots, preferably arranged stationary to each other. Here, delta robots are arranged opposite each other as lateral delta robots in such a way that they hold the vehicle to be washed laterally between them. These lateral delta robots are used accordingly for cleaning the doors and side surfaces of the vehicle. In addition or alternatively, the washing station may have one or a plurality of upper delta robots positioned above a positioning area for the vehicle to clean the roof of the vehicle. Furthermore, as an alternative or in addition, the washing station may have front or rear delta robots facing each other, which clean the front and rear surfaces of the vehicle and which hold the vehicle with these front and rear surfaces between them. Of the delta robots mentioned above, any or selected or only a single delta robot can be arranged to be vertically movable and/or longitudinally or transversely movable. At least one delta robot at the front or rear is usually height-adjustable to allow the vehicle to enter the positioning area. It goes without saying that one or a plurality of robots can also be provided under the floor of the vehicle to clean the vehicle.

According to a preferential further development of the present invention, the delta robot is connected to a linear guide, which preferably has a support movable in the longitudinal direction of a vehicle to be cleaned, via which the delta robot is linearly movable. This additional drive of the delta robot improves the reach of the same in a space-saving and light-weight construction, thus preserving the advantages of the delta robot of a better payload to dead weight ratio, so that the treatment element can be moved quickly and inertial forces do not make it too difficult to treat the vehicle in an alternating manner, if necessary.

The linear guide extends essentially in the longitudinal direction of the vehicle. This is to express that the main direction of extension of the linear guide corresponds to the main direction of extension of the vehicle. The linear guide need not be strictly parallel to the longitudinal direction of the vehicle.

The longitudinal direction of the vehicle to be cleaned corresponds to the direction of extension of a vehicle to be moved in a car wash and thus the direction of movement of the vehicles. The linear guides are usually provided on both sides of the vehicle, also in the lower area. Thus, the maximum transverse distance of the linear guides corresponds at least to the width of the vehicle plus a certain tolerance margin of between 10 and 20% of the vehicle width. Where the maximum transverse distance is used in the present case, this is due to the fact that the washing device may have a plurality of linear guides, which may be provided not only at the side of the vehicle but also above linear guides, i.e. diagonally above the vehicle and possibly relatively far centrally above the vehicle. Their transverse distance is naturally smaller than the transverse distance of the lower linear guides.

According to a preferred further development of the present invention, an intermediate element is arranged between the support and the actuation-side element, to which connecting rods and arm links are articulated. The connecting rods are provided between the support and the intermediate element. The connecting rods are usually not adjustable in length. These connecting rods can also be provided in pairs. Each rod of a pair of connecting rods usually extends parallel to the other rod of the same pair. The fastening of the connecting rods to the support or intermediate element is usually articulated. The joint usually has three degrees of freedom and is preferably designed as a ball joint. The arm links extend between the support and the work plate. The arm links are usually adjustable in length and regularly designed as hydraulic or pneumatic cylinders. For the best possible position of the treatment element, six arm links in the manner of a hexapod are usually provided. The ends of the arm links on the attachment side, which are relatively close to each other on the support, are relatively far apart on the side of the intermediate element, which enables a reliable and precisely controlled pivot movement of the treatment element. The arm links are also usually connected with three degrees of freedom, each articulated to the support and each articulated to the work plate. The work plate itself usually carries the treatment element directly, although the aforementioned types of attachment may be provided for the detachable connection of the treatment element to the work plate. In any case, the connection between the work plate and the treatment element is usually rigid, so that the alignment of the work plate corresponds exactly to the alignment of the treatment element relative to the surface of the vehicle to be cleaned.

The support is preferably designed as a lightweight component. The support is particularly preferred as a support arm structure with thin, rigidly connected support arms. Here, too, care should be taken to keep the weight of the intermediate element as low as possible, while at the same time providing the necessary stiffness to ensure that the treatment element is positioned securely and with sufficient pressure against the surface of the vehicle to be cleaned. The support arms can be made of carbon.

According to a further preferred design of the present invention, at least three linear guides, usually exactly three linear guides, are provided for each intermediate element. This provides a relatively simply designed washing device, which allows a number of degrees of freedom.

The three linear guides for each intermediate element are not in one plane in order to be able to control and change the position of the intermediate element in the best possible way.

Each set of three linear guides usually has a lower linear guide approximately at the level of the wheels of the vehicle to be cleaned, an upper linear guide above the vehicle and an outer linear guide approximately at the same level as the upper linear guide and at approximately the same distance from the vehicle as the lower linear guide. For the transverse distance of the lower linear guides of the different sets from each other, the above-mentioned is preferred. The height of the upper linear guide is chosen with regard to the usual height of the vehicles to be cleaned. The upper linear guide is usually located at a height above the ground of between 1.80 m and 2.50 m.

Of the three linear guides thus formed, which are assigned to each other via the intermediate element, two sets are preferably provided. This makes it possible to treat, in particular clean or polish, the side surfaces as well as the front and rear surfaces of a car as a whole with little equipment effort.

Of course, a plurality of sets of three linear guides each can be arranged on one of the long sides and/or front sides of a vehicle. For example, a lower set can clean the lower part and the side surfaces of the vehicle, while an upper set, positioned laterally of the vehicle, can clean the boot, bonnet and roof surfaces and the window surfaces which basically extend in this area.

Finally, according to another preferred design of the present invention, it is proposed that the ratio of the length of the connecting rods to the length of the vehicle to be cleaned is about 1/3 to 1/2. The length of the vehicle to be cleaned corresponds to the extension of the vehicle in its direction of travel. The vehicle is then twice to three times as long as the length of the connecting rods.

Components of the washing device may be equipped with LED lamps. In particular, the connecting rods and/or the intermediate element and/or the arm links may be provided with such LEDs.

The device may also include an adjusting means to vary the curvature of the work plate to match the curvature with the respective curvature of the surface to be cleaned. For example, the work plate can be made of an elastic material, such as plastic, and supported only at the edges by discrete support points or a circumferential frame. In the middle of the work plate, an adjust cylinder can act on the work plate, which is adjustable in length in order to bend the work plate convex and/or concave relative to the support. Such an adjust cylinder can, for example, be an element of the hexapod as a central adjust cylinder and thus be integrated into the hexapod

With the present invention an improved washing device for vehicles is provided. Vehicle within the meaning of the present invention shall be in particular motor vehicles, trucks or two-wheelers. Washing within the meaning of the present invention means any cleaning or drying of the vehicle. It is not necessarily necessary to apply liquid detergent. A washing device according to the invention can, for example, also dry and wipe the vehicle automatically after conventional cleaning in a car wash and thus only take over a partial step of a complex washing process. A car wash may also have one or a plurality of devices of the type claimed in the invention. A car wash may also include only devices of the type of the invention for performing various phases of cleaning a vehicle in a car wash, such as soaking, soaping, polishing, drying or sealing. An alternative to washing with liquid according to the present invention is to rub a polishing agent onto the surface of the vehicle and then polish it. All treatment steps which serve to improve the appearance of the vehicle are understood as “washing” in the sense of the present invention.

The present invention is explained below by means of an embodiment in connection with the drawing:

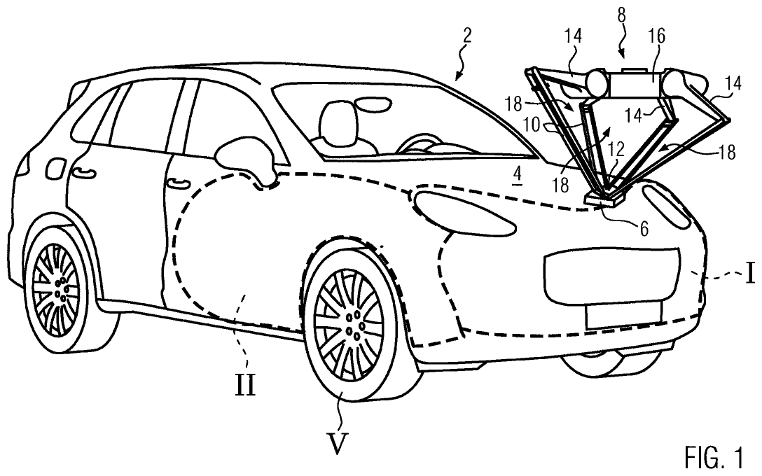

FIG. 1 shows a perspective side view of a vehicle to be washed with an embodiment of a delta robot

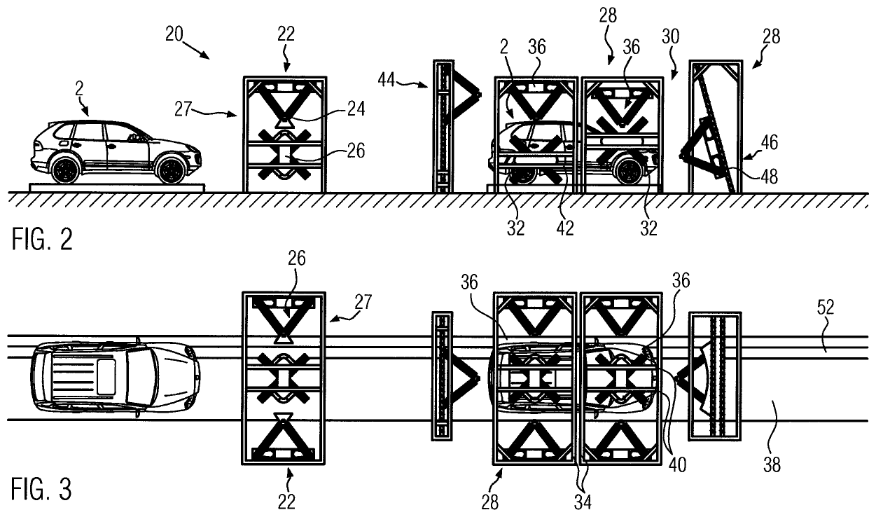

FIG. 2 shows a side view of a car wash of the present invention;

FIG. 3 shows a top view of the embodiment shown in FIG. 2;

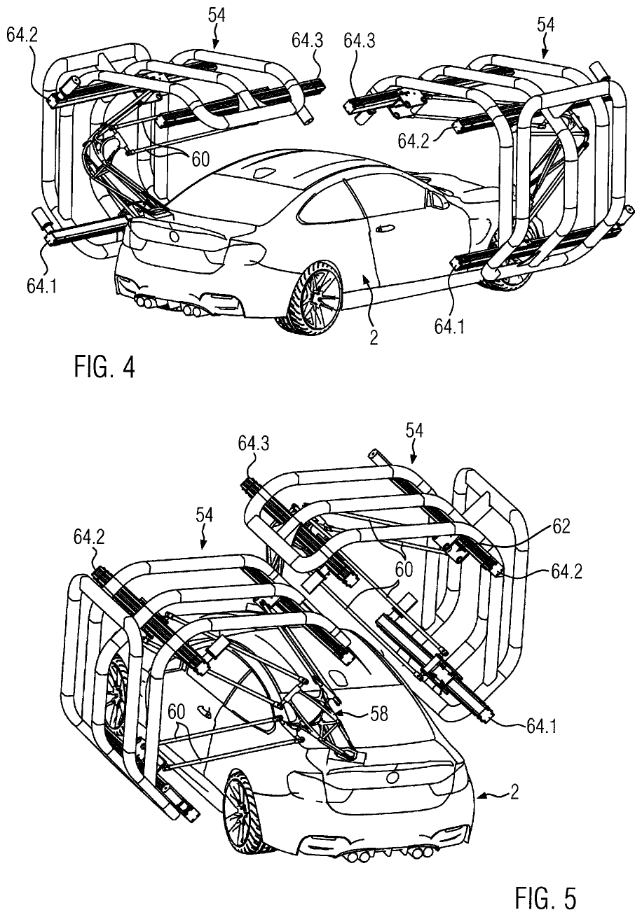

FIG. 4 shows a perspective, rear view of a vehicle to be washed when treated with a second embodiment of the washing device according to the invention;

FIG. 5 shows the representation according to FIG. 5 in a different perspective side view;

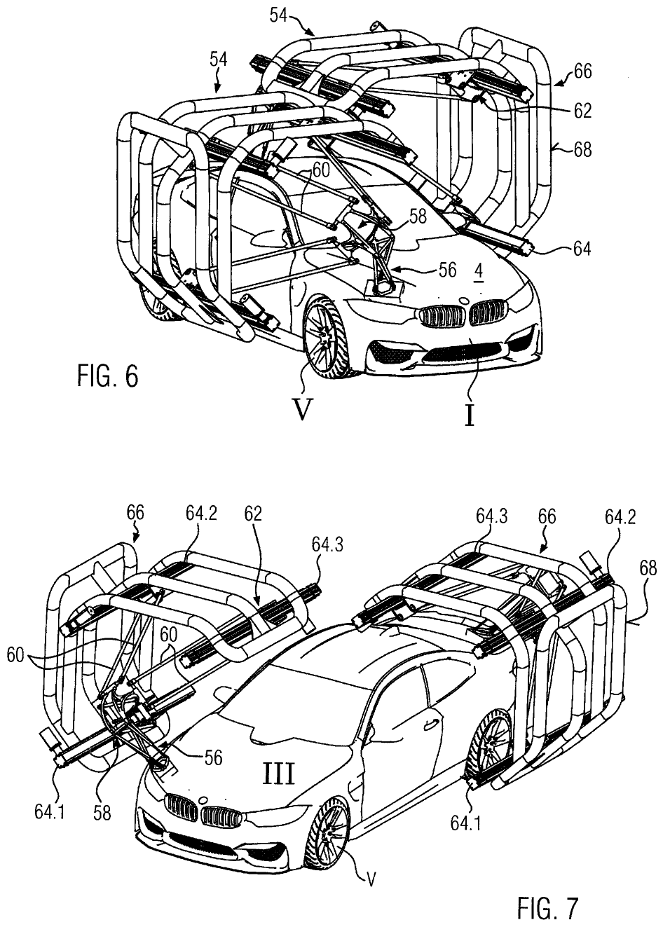

FIG. 6 shows the embodiment shown in FIGS. 4 and 5 when treating a front surface of a vehicle to be washed;

FIG. 7 shows the representation shown in FIG. 7 for a different perspective view;

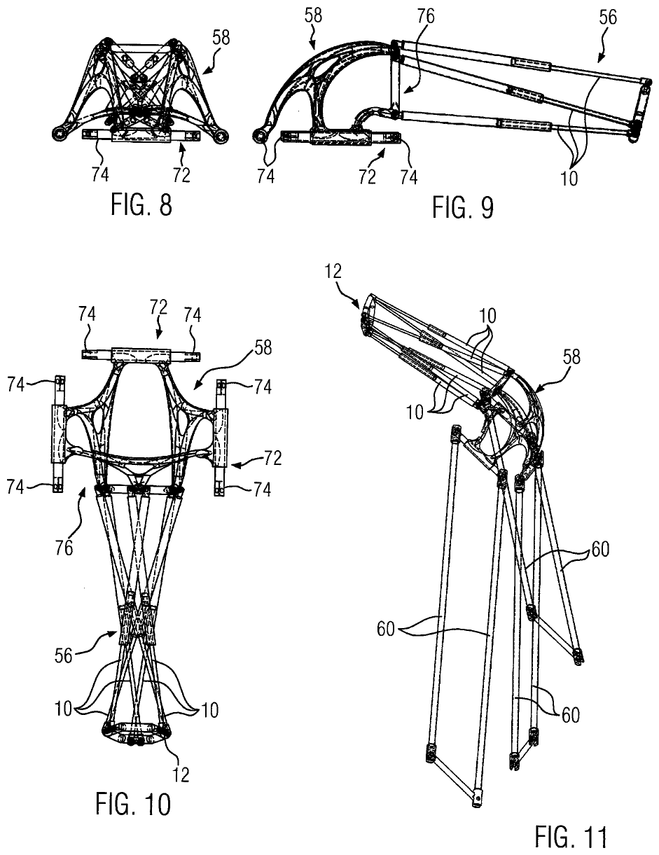

FIG. 8 shows a frontal view of an intermediate element with hexapod;

FIG. 9 shows a side view of an intermediate element with hexapod;

FIG. 10 shows a top view of an intermediate element with hexapod;

FIG. 11 shows a perspective side view of the intermediate element with hexapod and

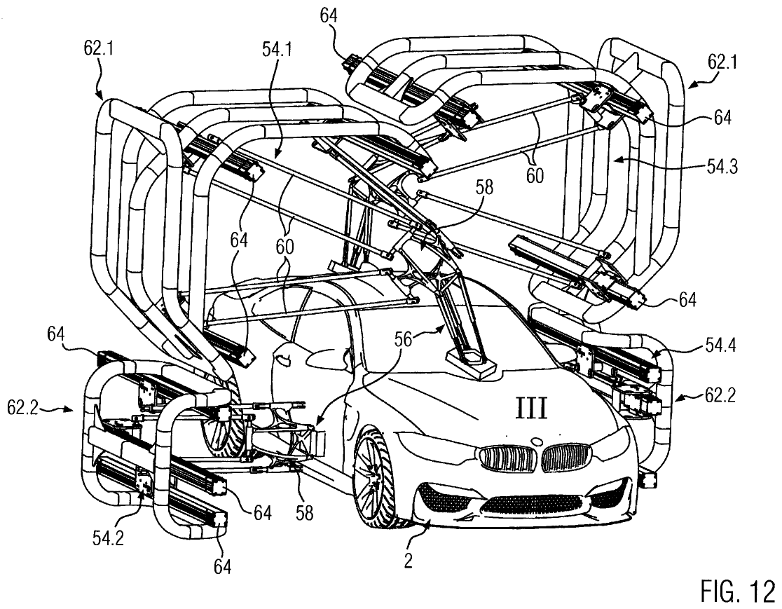

FIG. 12 shows a perspective view similar to that shown in FIG. 6 for an alternative embodiment.

FIG. 1 shows a perspective view of a vehicle to be washed in the form of a passenger car 2, to which a cleaning element in the form of a cleaning sponge 6 is operatively connected in the area of the bonnet 4. The cleaning sponge 6 is held and moved by a delta robot marked with reference numeral 8. For this purpose, the delta robot 8 has four arm links 10, each of which is designed as a double arm link and is connected at its ends on the actuation side to a work plate 12, which carries the cleaning sponge 6, and is articulated at its opposite end to one drive arm 14 each. This drive arm 14 can be pivoted by means of a motor not shown in detail, which is attached to a base 16. The delta robot 8 has four drive arms 14 with corresponding arm links 10. Thus 10 different parallelograms are formed by the arm links, which are marked with reference numeral 18.

By driving the drive arms 14, the work plate 12 can be pivoted with regard to its horizontal alignment in order to place the cleaning sponge 6 as plane-parallel as possible on the surface of the passenger car 2. In addition, the cleaning sponge 6 can be moved relative to the bonnet 4 by driving the drive arms 14.

FIG. 1 shows different areas of the passenger car 2 that require cleaning of varying intensity. A front area is marked with I, which includes the radiator and the lamps of the driving light and which gets dirty during fast driving, especially in the form of insects and stone chips. The high speed at which the dirt flows against the front area I results in an intensive degree of soiling and stubborn dirt on the surface of the passenger car 2.

A section of the mudguards and a front area of the doors are marked II. This lateral front area II experiences less soiling compared to the front area I. The upper part of the bonnet following the front area I in the direction of travel is marked III. All window areas form an area IV.

The invention, with its specific embodiment, is guided by the consideration of cleaning the respective areas I-IV in accordance with the material composition of the surface or the degree of soiling. Thus the front area I is exposed to considerably more contact pressure and higher intensity in the form of high relative speed and high contact pressure between the cleaning sponge 6 and the surface of the passenger car 2 and/or high-frequency oscillating movement.

In contrast, the lateral front area II is cleaned more moderately. These two areas I and II as well as the bonnet area III can be cleaned with the same cleaning sponge 6, whereby the bonnet area III is treated with even less cleaning intensity.

The window area IV is cleaned with a cleaning element optimally adapted to glass cleaning. The same applies to the wheel area marked with reference numeral V, which includes the rims and also partly the tires.

It goes without saying that the cleaning of a passenger car 2 can be done with only one delta robot 8. This can then be moved relative to the passenger car 2, preferably in the height, width and length direction of the vehicle.

FIGS. 2 and 3 illustrate an embodiment of a car wash 20. The car wash 20 has a recognition station 22 with an upper camera 24 and side cameras 26 that can optically measure and recognize the vehicle 2 as it passes through the recognition station 22. This allows all areas to be broken down and analyzed. These cameras 24, 26 are each kept movable by delta robots 27 of the recognition station 22, in order to enable as many different projections as possible on the vehicle 2. The data thus obtained are processed in a control unit, not shown, in order to select or calculate a cleaning program adapted to the design of the passenger car 2. The cleaning program may include data representing the exterior design of the passenger car 2 which, after recognition of the model and generation of the model, is read out for the corresponding model and transmitted to a washing station marked with reference numeral 26 for the purpose of developing an individual cleaning program for the corresponding vehicle. This washing station has two lateral delta robots 32 on each side of the passenger car 2, each mounted on a frame 30, which can be moved in height. Lateral delta robots 32 opposing each other laterally accommodate the passenger car 2 to be washed between them. Accordingly, the lateral delta robots 32 “see” the mudguards, wheels, doors and lateral rear surfaces as well as the lateral window front of passenger car 2. The frame 30 has horizontally extending cross struts 34, which support two upper delta robots 36, which are located above a positioning area 38 for the vehicle 2 to clean the roof of the vehicle 2. The cross struts 34 each carry longitudinal guides 40, which in turn are displaceably guided on the cross struts 34 in order to move the upper delta robots with their base 16 in a horizontal plane relative to the vehicle roof. As can be seen, the lateral delta robots 32 are not only height-adjustable, but can also be moved vertically and horizontally via cross beams 42, which are mounted on the frame 30.

Front and rear frames 44, 46 are provided to accommodate the positioning area 38 between them. The frame 46 at the rear in the direction of movement of vehicle 2 carries a front delta robot 48. The frame 44 at the front in the direction of movement of vehicle 2 carries a rear delta robot 50. The delta robots 48, 50 are mounted on the frames 44, 46 so that they can be moved transversely and vertically in order to clean the front and rear sections of the passenger car 2.

Reference numeral 52 identifies a conventionally designed movement device for moving the vehicle through car wash 20.

The vehicle 2 to be washed is first guided through the recognition station 22. The cameras 24, 26 are moved by the assigned delta robots in order to record as many details of the passenger car 2 as possible. The optical data thus obtained is processed by a processor of the control device. This processor also controls the movement of the various delta robots 32, 36, 48, 50 of the washing station 28, whereby the cleaning elements 6 provided on the corresponding robots 32, 36, 48, 50 are not only guided parallel to the surface to be cleaned with a predetermined movement pattern. Rather, the cleaning intensity is also adapted to the degree of soiling.

FIGS. 4 to 7 show side views of a second embodiment of a washing device according to the invention. Compared to the first embodiment according to FIGS. 1 to 3, identical elements are marked with identical reference numerals.

The embodiment shown in FIGS. 4 to 7 has two identically designed sub-groups 54, each of which has a delta robot designed as a hexapod 56 which, like the first embodiment, carries a cleaning sponge at its actuation-side end, the hexapod 56 with its six length-adjustable arm links 10 being supported via a support arm structure 58 formed by a plurality of connecting rods forming an intermediate element. The support arm structure 58 is explained in more detail below with reference to FIGS. 8 to 10.

The support arm structure 58 is articulated via connecting rods 60 to a support 62. The support 62 is mounted on a frame 66 via a linear guide 64. The connecting rods 60 are each provided in pairs. The connecting rods, which are combined to form a pair, extend parallel to each other and are articulated at equal distances on the support 62 on the one hand and on the intermediate element 58 on the other. The connection to the support 62 and the intermediate element 58 is made by ball joints. The frame 66 has a contact surface 68 adapted to abut against a building wall of a car wash, which is not shown. The frame 66 consists of welded beams 70.

The frame 66 supports a lower linear guide marked with reference numeral 64.1, which is provided at the level of the wheels of the passenger car 2. In the vertical direction above it, the frame 68 supports an outer linear guide 64.2. An upper linear guide 64.3 is provided above the vehicle and supported by the frame 68, approximately at the same level with this outer linear guide 64.2. Each of the linear guides 64.1, 64.2, 64.3 displaceably guides one support 62 each. By relative positioning of the respective supports 62, the support arm structure 58 can be moved not only relative to the passenger car 2 in its longitudinal direction. Rather, relative movements of the supports 62 of a sub-group 54 in relation to each other can also cause a change in the angular orientation of the support arm structure 58 relative to the passenger car 2. This results in a certain positioning of the hexapod 56, which can also position and move the cleaning sponge 6 relative to the surface of the passenger car 2 to be cleaned.

As shown in particular in FIG. 4, the two sub-groups 54 are provided to be offset in the longitudinal direction of the vehicle, i.e. in the direction of travel. They are designed so that the slightly rearward sub-group 54 can clean the rear area VI but not the front area I of the passenger car 2, while the front sub-group 54 with the work plate 12 and the cleaning foam 6 provided on it can reach the front surfaces of the vehicle but not the rear area VI and the rear bumper.

Each frame 66 may be individually movable on horizontal rails extending in the longitudinal direction of the vehicle. The support is preferably implemented through rollers or wheels. The frames 66 can also be driven in order to follow a movement of the vehicle 4 to be cleaned, for example. The previously described offset of the two-sided sub-groups 54 increases the effective cleaning with only two sub-groups 54.

FIGS. 8 to 10 illustrate elements of the support arm structure 58. As already mentioned above, the support arm structure 58 serves to connect the connecting rods 60. For this purpose, the support arm structure 58 has three continuous axle beams 72, at the free ends 74 of which the connecting rods 60, which are provided in pairs, are articulated. These free ends 74 do not necessarily each have to be formed by a one-piece axle beam 72. However, the free ends 74 with their longitudinal axis are in one plane or parallel to this plane. As FIG. 8 illustrates, the axle beams 62 are arranged in a single plane. However, it is sufficient to arrange the axle beams 72 or the free ends 74 in each case in such a way that they extend parallel to the plane to be seen in FIG. 8. An arrangement in the same plane is not absolutely necessary. The support arm structure 58 forms a mounting base 76 for connecting the hexapod 56. The attachment points formed by this mounting base 76 for hexapod 56 lie in a plane perpendicular to the plane of the free ends 74 (see FIGS. 9, 10). The mounting base, which is usually designed as a hexagon, is engaged by the mounting ends of the arm links 10, which are designed as length-adjustable cylinders. At the other end of the latter, work plate 12 is shown.

The support arm structure 58 is usually designed as a lightweight component. In this way, the axle beams 72 can be formed from metal and—as shown in particular in FIG. 10—can be circumferentially enclosed by the carbon material to create a tight connection between the axle beam 72 and the carbon material. The angular, preferably right-angled orientation of the mounting base 76 relative to the plane formed by the free ends 74 for connecting the connecting rods 60, allows the work plate 12 to be better positioned relative to the surface of the vehicle to be cleaned.

FIG. 12 shows a modified embodiment in which the washing device is equipped with four assemblies 54.1 to 54.4, each of which is mounted on a separate support 62.1 or 62.2 and attached to a wall. The connection to the wall can also be done in a movable way as described above. The lower assemblies 54.2 and 54.4 are used to clean the lower parts of the vehicle, whereas the upper assemblies 54.1 and 54.3 clean the upper part of the vehicle. Two sub-groups 54.1, 54.2 or 54.3, 54.4 are provided on each longitudinal side of the vehicle.

Thus, four different work plates with associated cleaning elements are in use.

### LIST OF REFERENCE NUMERALS

2 passenger car
4 bonnet
6 cleaning sponge
8 delta robot
10 arm links
12 work plate
14 drive arm
16 base
18 parallelogram
20 car wash
22 recognition station
24 upper camera
26 side camera
27 frame
28 washing station
30 frame
32 lateral delta robot
34 cross strut
36 upper delta robot
38 positioning area
40 longitudinal guide
42 cross beam
44 front frame
46 rear frame
48 front delta robot
50 rear delta robot
52 moving means
54 sub-group
56 hexapod
58 support arm structure/intermediate element
60 connecting rod
62 support
64 linear guide
66 frame
68 abutment surface
70 carrier
72 axle beam
76 mounting base
I front area
II lateral front area
III bonnet area
IV window surface area
V wheel area
VI rear area

1. Washing device for vehicles with at least one delta robot, which carries a treatment element at its actuation-side end.

2. Washing device according to claim 1 wherein the treatment element is formed as a cleaning element for direct contact with a surface of the vehicle and/or as a spraying element for spraying-on a cleaning or care substance and/or as a drying element adapted to dry the vehicle.

3. Washing device according to claim 1 wherein the delta robot is controlled by a control device which processes contour data on the shape of the vehicle to be cleaned for positioning the treatment element and cleaning intensity data, which adapts at least one of the following parameters depending on a cleaning effort varying over the surface of the vehicle: acting pressure of the treatment element against the surface of the vehicle to be cleaned; acting speed of the treatment element against the surface of the vehicle to be cleaned; acting duration in a predetermined surface area of the vehicle; acting movement pattern of the treatment element in a predetermined surface area of the vehicle.

4. Washing device according to claim 1 wherein the delta robot is controlled by a control device in dependence on weather and/or seasonal data and/or in dependence on an individual pre-adjustment preset for a specific vehicle owner.

5. Washing device according to claim 1 further comprising a treatment element magazine, to which the delta robot has access for automatic exchange of the treatment element and in which differently contoured treatment elements are provided.

6. Washing device according to claim 1 further comprising a treatment element treatment station for regeneration of used treatment elements.

7. Washing device according to claim 6, wherein the treatment element treatment means comprises a circumferential treatment path on which the treatment elements are cleaned and/or checked and/or provided with cleaning and/or polishing agent and/or exchanged and/or dried.

8. Washing device according to claim 1 wherein the washing device is designed as a car wash with a moving means for moving the vehicle and a front recognition station in the direction of movement of the moving means and a rear washing station in the direction of movement of the moving means with at least one delta robot, the recognition station having a recognition means for recognizing the moving vehicle and a control device controlling the delta robot, using findings thereby obtained on the position, type and/or equipment of the vehicle to prescribe a cleaning program for the vehicle.

9. Washing device according to claim 1 wherein the washing device comprises a washing station with a plurality of delta robots arranged substantially vertically and opposite each other to receive the vehicle to be washed between them and/or arranged above a positioning area for the vehicle to clean a roof of the vehicle and/or arranged opposite each other above the positioning area to receive a front or rear of the vehicle between them.

10. Washing device according to claim 1 wherein the delta robot is connected to a linear guide.

11. Washing device according to claim 10, wherein between a support and an operating end there is arranged an intermediate element to which connecting rods and arm links are articulated, wherein the connecting rods extend between the support and the intermediate element and wherein the arm links extend between the support and a work plate to which the treatment element is connected.

12. Washing device according to claim 11, wherein at least three linear guides are provided for each said intermediate element.

13. Washing device according to claim 10 wherein two sets are provided, the sets being assigned to different longitudinal sides of a vehicle to be cleaned, each having at least three linear guides.

14. Washing device according to claim 1 wherein at least one arm link, and/or at least one connecting rod and/or an intermediate element is provided with LEDs.

15. Washing device according to claim 13 wherein the linear guides of a set are fixed to a frame which is displaceable in a longitudinal direction of the vehicle.
